(19) United States
(12) Patent Application Publication
(10) Pub. No.: US 2010/0146587 A1
(43) Pub. Date: Jun. 10, 2010

(54) AUTHENTICATION OF CONTROLLED DOSING PROCESSES

(75) Inventors: Brian L. Sholes, Minneapolis, MN (US); Christopher J. Opelt, Hampton, MN (US); Joshua P. Magnuson, Saint Paul, MN (US); Megan W. Malvey, Shoreview, MN (US)

Correspondence Address: SHUMAKER & SIEFFERT, P. A., 1625 RADIO DRIVE, SUITE 300, WOODBURY, MN, 55125, US

(73) Assignee: Ecolab Inc., St. Paul (US)

(21) Appl. No.: 12/331,060

(22) Filed: Dec. 9, 2008

(51) Int. Cl. G06F 21/00

(52) U.S. Cl. 726/2

(57) ABSTRACT

Authentication of products dispensed in an automated chemical dispensing system occurs via electronic communication of product information. The dispensing system includes a plurality of dispense stations, each of which is configured to dispense a corresponding specified chemical product. A product container includes an electronically readable label or tag that includes product information that identifies the chemical product in the container. A product dispenser reads the product information and automatically determines whether the specified product has been loaded onto or into the dispense station. If the product is thus “authenticated,” the system may permit dispensing of the chemical product. If the product is not authenticated, the system may prevent dispensing of the chemical product and/or generate an error message.

### TECHNICAL FIELD

The invention relates to automated control of chemical product dispensers.

### BACKGROUND

Automated chemical product dispensers are useful in many different chemical application systems, including cleaning systems relating to food and beverage operations, laundry operations, warewashing operations (e.g., dishwashers), water treatment operations, pool and spa maintenance, as well as other systems, such as and agricultural operations. For example, chemical products used in food and beverage operations may include sanitizers, sterilants, cleaners, degreasers, lubricants, etc. Chemical products used in a warewashing or laundry operation may include detergent, de-ionized water, sanitizers, stain removers, rinse agents, etc. Chemical products used in a laundry operation may include detergent, bleaches, stain removers, fabric softeners, etc. Chemical products used in agriculture may include without limitation pesticides, herbicides, hydration agents, and fertilizers. Other chemical products may include without limitation glass cleaning chemicals, hard surface cleaners, antimicrobials, germicides, lubricants, water treatment chemicals, rust inhibitors, etc.

Automated chemical product dispensers can reduce labor and chemistry costs by automatically delivering predetermined amounts of chemicals in a proper sequence and in proper amounts, often times in very large quantities or at high speeds. Furthermore, some chemical products can be hazardous in concentrated form; therefore, automated chemical product dispensers reduce the risks of exposure to operators, who may otherwise measure and deliver the chemical products manually.

Product dispensers dispense a wide variety of chemical products in a variety of different forms. Some dispensers dispense products in liquid, gel or powder form. Other dispensers may use a water spray to gradually dissolve a solid product to create a use solution. The chemical product may be dispensed to a dispensing site, such as a container (bucket, pail, tank, etc.), wash environment (dishwasher, laundry machine, car wash, etc.), machinery (food or beverage processing equipment, manufacturing facility, etc.) or other environment in which the chemical product is to be used.

### SUMMARY

In general, the invention is related to authentication of products dispensed in an automated chemical dispensing system. The authentication occurs via electronic communication of product information. A product container includes an electronically readable label or tag that includes product information concerning the chemical product in the container. A product dispenser includes an electronic label reader that reads the product information and automatically determines whether the specified product has been loaded onto or into the dispenser.

In one embodiment, the invention is directed to a system comprising a plurality of electronically readable labels, each associated with a different one of a plurality of product containers, wherein each electronically readable label stores product information that identifies a chemical product in the associated product container and transmits the product information in the presence of an interrogation signal, a plurality of dispense stations, each associated with a specified one of a plurality of chemical products and each of which receives a product container containing a chemical product to be dispensed, each dispense station comprising a dispensing tank, an electronically controllable valve that controls emptying of the chemical product from the product container into the dispensing tank, and a station antenna that generates the interrogation signal and receives the product information transmitted by the electronically readable label, an interrogator that activates the station antenna to generate the interrogation signal and receives the product information from the station antenna, and a controller that receives the product information from the interrogator, determines whether to authenticate the received product information and generates a control signal based on the determination.

In another embodiment, the invention is directed to a method comprising receiving product information that identifies a chemical product contained in a product container loaded onto a dispense station, comparing the received product information with product information corresponding to a specified chemical product associated with the dispense station, authenticating the received product information when the received product information matches the product information corresponding to the specified chemical product, and preventing dispensing of the chemical product when the received product information does not match the product information corresponding to the specified chemical product.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example chemical product dispensing system that includes product authentication.

FIG. 2 is a flow chart illustrating an example process of creation, application and verification of an electronic label or tag to a chemical product container.

FIG. 3 is a flowchart illustrating an example process of authentication of a product container.

FIG. 4 is a flowchart illustrating an example process performed by a technician to load a product container and set up a dispense station.

### DETAILED DESCRIPTION

In automated chemical dispensing systems, individual dispense stations may be assigned to dispense a specified chemical product to one or more dispensing sites. To that end, a dispense station may be configured to dispense controlled doses of a specified chemical product at predetermined times based on the specified type of chemical product, its concentration, etc. An operator or service technician typically loads the product containers onto the dispense station, either manually in the case of relatively small product containers or with the help of automated machinery or equipment in the case of larger containers. Operator error, however, may sometimes result in an incorrect chemical product being installed or loaded into a dispenser that is not configured to dispense that particular chemical product. Some of these errors may be relatively benign, such as when one brand of laundry detergent is accidentally or intentionally substituted for another brand of laundry detergent. However, some of these errors may be very costly in terms of health and safety or item/equipment damage. For example, the health and/or safety of thousands of people may be at stake when a non-sanitizing product is mistakenly loaded onto a dispenser that is expected to deliver a sanitizing product to equipment in a food or beverage processing plant. Extensive equipment damage may occur if a caustic substance is erroneously loaded onto a dispenser not designed to withstand the corrosive effects of such substances, or subsequently into a manufacturing or processing system not designed for such substances. And, improper mixing of noncompatible chemical products may cause dangerous, harmful reactions resulting in fires, explosions and subsequent personal injury and property damage.

In general, the invention is related to authentication of chemical products dispensed in an automated chemical dispensing system that includes at least one chemical product dispense station. Authentication occurs via electronic communication of product information. A product container includes an electronically readable label or tag that includes product information that identifies the chemical product in the product container. Each chemical product dispense station is configured to deliver a specified chemical product to at least one dispensing site. After a product container is loaded onto the dispenser, the system reads the product information from the electronically readable label and automatically determines whether the specified product has been loaded onto the dispense station. If the specified product is authenticated (that is, if the specified product is determined to have been loaded onto the dispense station) the system allows the chemical product to be used or dispensed. If the chemical product is not authenticated (that is, the system determines that an incorrect product has been loaded onto the dispense station) the system may activate a station lock-out that prevents the incorrect product from being used or dispensed. By automatically authenticating that the specified chemical product has been loaded onto the dispense station before allowing it to be used or dispensed, errors due to incorrect product loading may be reduced or eliminated.

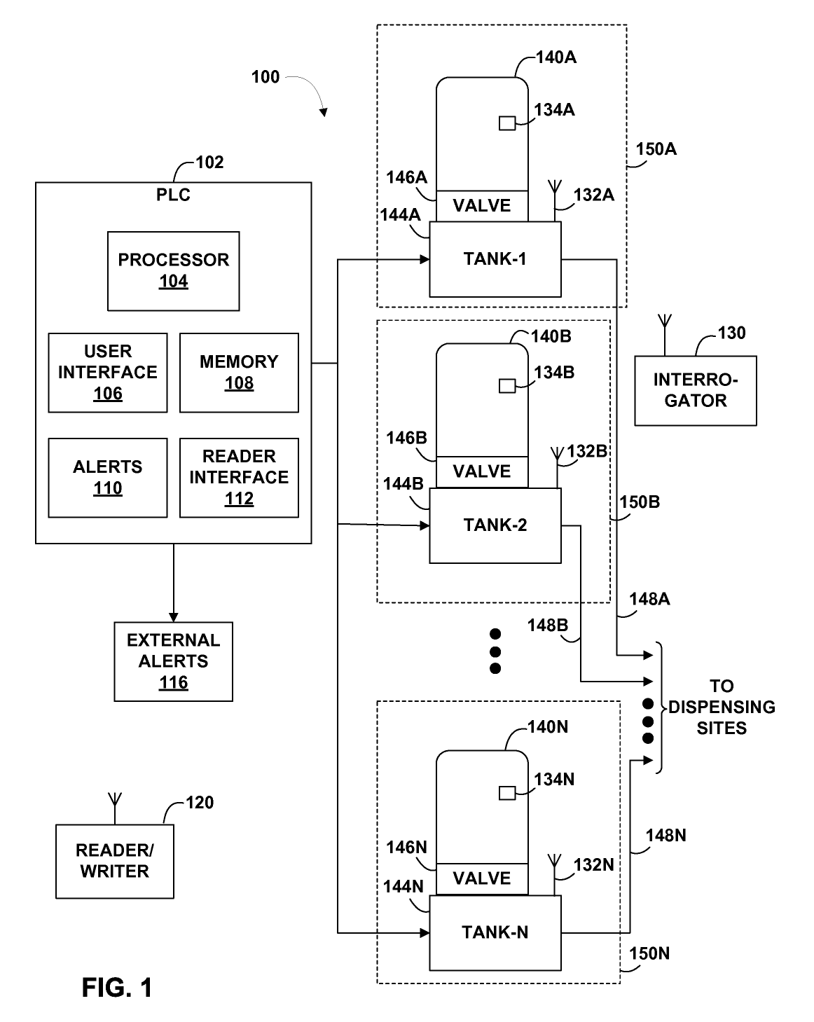

FIG. 1 is a block diagram illustrating an example automated chemical product dispense system 100 that includes chemical product authentication. System 100 includes one or more product dispense stations 150A-150N, each of which dispenses a controlled dose of a specified chemical product to one or more dispensing sites. Each dispense station 150A-150N includes a product container 140A-140N and a dispensing tank 144A-144N. Each dispensing tank 144A-144N includes an electronically controlled valve 146A-146N which, when opened, allows the contents of the associated product container 140A-140N to be dumped into the respective dispensing tank 144A-144N. At the appropriate times, the chemical products are pumped from dispensing tanks 144A-144N and delivered via fluid delivery lines 138A-138N to various dispensing sites.

In this example, product containers 140A-140N are shown as chemical storage totes of the type designed to store hundreds or thousands of liters of chemical product for large scale chemical product dispensing. Such large scale dispensing systems are common in, for example, food and beverage processing facilities. It shall be understood, however, that the authentication processes and systems described herein may be used with other types of automated dispensing systems, such as those used in commercial laundry operations, warewashing (dishwashing) operations, agricultural operations, manufacturing operations, etc. In some applications, for example, the dispense stations 150A-150N may not include dispensing tanks 144A-144N. In those examples, the chemical products may be dispensed directly from the product containers rather than being first emptied into a dispensing tank. Thus, it shall be understood that various types of dispensing systems and dispense stations may be used without departing from the scope of the present invention.

Each product container 140A-140N includes an associated electronically readable label 134A-134N. Each electronically readable label 134A-134N stores product information concerning the chemical product in the associated product container 140A-140N. For example, each electronically readable label may include information concerning the name of the product, the type of product, the concentration of the product, the product manufacturer, the date the product was manufactured, the expiration date of the product, if any, and any other product related information.

In one example, electronically readable labels 134A-134N are implemented using radio frequency identification (RFID) transponders or tags. The typical RFID tag includes an integrated circuit chip that stores product information and an antenna for receiving a radio frequency interrogation signal and for transmitting the identification information. RFID tags may be active, passive or semi-passive and may operate at any appropriate frequency. RFID tags may also be read-only, read/write or a combination. In other examples, electronically readable labels 134A-134N may be implemented using other mechanisms for electronically storing and conveying product information, such as bar codes, conductive inks, printed circuits, etc. Thus, although the phrase “electronically readable label” is used throughout this specification, it shall be understood that any electronically readable medium that may be used to store and convey product information that is known or will be known to those of skill in the art may be used and that the invention is not limited in this respect.

A reader/writer 120 may be used to print and/or encode labels 134A-134N with the product information. If electronically readable label 134A-134N is incorporated into the product packaging, e.g., via a so-called “smart label” that combines human readable or text information with electronically readable information such as bar codes or RFID, the printed matter may be written using a conventional printer and the label 134A-134N encoded using reader/writer 120. In some examples, reader/writer 120 may be a handheld device. In other examples, reader/writer 120 may be an RFID printer or other device suitable for encoding electronically readable label 134A-134N.

Each dispense station 150A-150N includes a station antenna 132A-132N. At least one interrogator 130, using station antennas 132A-132N, captures product information from the electronically readable labels 134A-134N and passes the data to a programmable logic controller (PLC) 102 for processing. In the passive RFID example, interrogator 130 is a radio frequency (RF) transmitter and receiver, controlled by a microprocessor or digital signal processor. Interrogator 130 activates station antennas 132A-132N to generate RF interrogation signals that induce an electrical current in the associated electronically readable label 134A-134N. In response to an interrogation signal, each label 134A-134N transmits its stored product information, which is in turn transmitted to interrogator 130 via antennas 132A-132N. The product information received by interrogator 130 includes the product information from electronically readable label 134A-134N and also includes dispense station information that differentiates the source (e.g., which station antenna 132A-132N) from which the product information was received.

The number of interrogators 130 deployed in the system may vary depending upon the number of dispense stations and thus the number of antennas required in each particular dispensing system, and the number of antenna ports on the particular RFID reader chosen for the system. It shall be understood, therefore, that the number of interrogators 130 may vary depending upon the particular system implementation and that the invention is not limited in this respect.

PLC 102 includes a processor 104, user interface 106, a memory 108, alert(s) 110 and a reader interface 112. Processor 104 controls the overall operation of system 100. User interface 106 may include, for example, a display, touch screen, keyboard or keypad, mouse, or other type of user interface that allows a technician to view and receive status information concerning the chemical dispense system and/or control various aspects of chemical dispense system 100. Memory 108 stores all necessary programming for PLC 102, including system set up information, control algorithms, dispense station configuration information, chemical product information, etc. Alerts 110 may include audible and/or visual alerts, such as LED indicators, alarms, etc. These alerts 110 may be used to indicate various system parameters such as system on/off, dispense station on/off, product authentication, etc. External alerts 116 may also be used to communicate system status information to remote users. Such external alerts 116 may include, for example, visual alerts such as colored lights installed in a large-scale industrial processing plant that indicate the status of each dispense station, LED status indicators, or other visual indicators. External alerts 116 may also include audible alerts such as alarms or buzzers. As another example, external alerts 116 may also include any form of electronic communication, such as alerts that are communicated to remote users via e-mail, voice mail, text message, pager, cell phone, personal digital assistant or other form of electronic communication.

A reader interface 112 permits communication between PLC 102, interrogator 130 and reader/writer 120, if desired. In one example, reader interface 112 communicates with interrogator 130 and/or reader/writer 120 via a wired connection, such as an Ethernet connection (not shown) or other wired communication protocol. In another example, reader interface 112 communicates wirelessly with interrogator 130 and/or reader/writer 120. Alternatively, there may be no need for communication between PLC 102 and reader/writer 120, in which case reader interface 112 facilitates communication between PLC 102 and interrogator 130.

Upon loading of a new product container 140A-140N onto a dispense station 150A-150N, system 100 authenticates product container 140A-140N before allowing any of the chemical product within product container 140A-140N to be removed. In one example, system 100 detects when a new product container 140A-140N is loaded onto a dispense station and automatically initiates an authentication query to determine whether the specified chemical product has been loaded onto the dispense station. In another example, an authentication query is manually initiated by an operator via user interface 106 of PLC 102 whenever a new product container 140A-140N is loaded. In another example, an authentication query may be initiated remotely.

Assume for sake of illustration that a new product container 140A has been loaded onto dispense station 150A. Regardless of whether the authentication query is manually or automatically initiated, PLC 102 directs interrogator 130 to interrogate electronically readable label 134A at the relevant dispense station 150A. Interrogator 130 receives the product information from the relevant station antenna 132A and transmits the product information to PLC 102. Processor 104 then authenticates the product container; that is, processor 104 determines whether product container 140A contains the chemical product specified for that dispense station 150A. If processor 104 determines that the product information received from label 134A matches the product information corresponding to the specified product, the product container is said to be “authenticated.” At this point, processor 104 may then permit the chemical product within product container 140A to be removed, dispensed, or otherwise used. For example, processor 104 may generate a control signal that permits electronically controlled valve 146A to open and empty the contents of product container 140A into the associated dispense tank 144A. In another example, for those systems in which the chemical product is dispensed directly from product container 140A, processor 104 may generate a control signal that permits dispense station 150A to dispense the chemical product to the one or more dispensing sites. Processor 104 may also store data summarizing the results of the authentication query (e.g., authentication codes, the received product information, a dispense station id, a station antenna id, a reader id, a date and time stamp, etc.) in memory 108.

Assume, again for purposes of illustration, that a new product container 140B has been loaded onto dispense station 150B. If processor 104 determines that the product information received from label 134B does not match the product information corresponding to the specified product for dispense station 150B, processor 104 will not authenticate product container 140B. When a product container is not authenticated, processor 102 may take one or more courses of action. For example, processor 104 may generate an error message indicating that an incorrect container has been loaded into dispense station 150B. The error message may be displayed on user interface 106, via alert(s) 110 or via external alerts 116. The error message may also be communicated via e-mail, voice mail, text message, pager, cell phone, personal digital assistant, or other form of electronic communication via an internet connection (not shown). Processor 104 may also activate a station lock-out. That is, processor 104 may generate a control signal that prevents use, removal or dispensing of the chemical product from within the incorrectly loaded product container 140A-140N. For example, processor 104 may generate a control signal that prevents the opening of electronically controlled valve 146B so as to prevent the emptying of the contents of container 140B into dispense tank 144B. Alternatively, processor 104 may shut down dispense station 150B, or otherwise prevent use of the incorrectly loaded chemical product. Processor 104 may also store data summarizing the results associated with the authentication query (e.g., error codes, product identification information, a dispense station id, a station antenna id, a reader id, a date and time stamp, etc.) in memory 108.

The contents of memory 108 may be queried or downloaded at a later time to allow users, either locally or remotely, to monitor operation of dispensing system 100. The contents of memory 108 may also be used to generate reports concerning product usage and overall dispensing system performance. These reports may be viewed locally or remotely, e.g., over the internet or other network. The reports may be generated on demand or may be generated automatically at predetermined intervals and automatically sent to one or more designated users, such as monitoring entities or corporate clients.

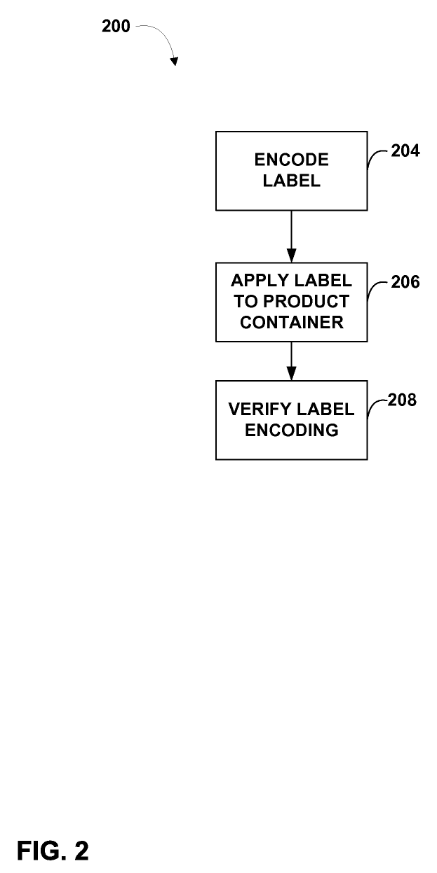

FIG. 2 is a flow chart illustrating an example process of creation, application and verification of an electronically readable label (200). Reader/writer 120 encodes the label with the product information that identifies the chemical product stored in the container to which the label will be affixed (204). The label is then applied to the appropriate location on the product container (206). The location may vary depending upon the type of product, the size and shape of the container, the eventual location and orientation of the product container relative to the dispense station, product container manufacturing processes, resistance to damage, repeatability, etc. For example, for certain containers, a location inside the HAZMAT shipping sleeve or other labeling on the product container may be an appropriate location to affix the electronically readable label. As another example, the electronically readable label may be affixed somewhere on the product container itself. Alternatively, the electronically readable label may be affixed directly to the product itself (in the case of solid products, for example), or may embedded into the product during the manufacturing process.

Reader/writer 120 verifies the label encoding (208). In other words, the reader/writer 120 reads back the product information from the electronically readable label after it has been affixed to the product container (or product itself) and verifies whether the label was properly encoded. If the label was not properly encoded, the label may be encoded again or a properly encoded label may be used in its place.

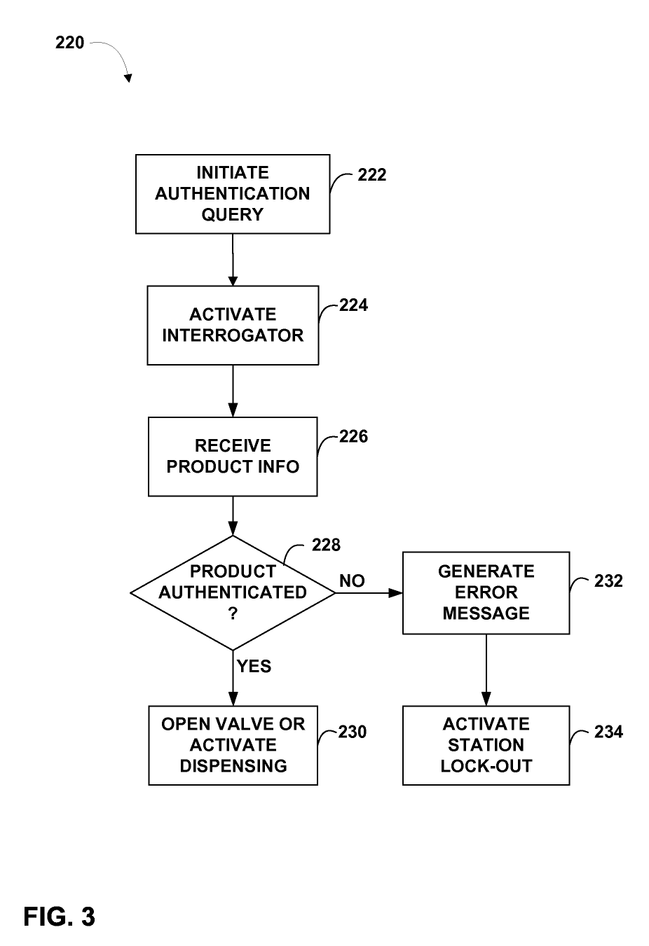

FIG. 3 is a flowchart illustrating an example authentication process (220). An authentication query at one or more dispense stations is initiated (222). The authentication query may be initiated manually by a technician or may be automatically generated. An authentication query may be manually initiated upon loading of a new product container onto a dispense station or at some other appropriate time. An authentication query may be automatically generated, for example, at predefined periodic intervals, when the product level in one of the tanks 144 is below a predefined level, when loading of a new product container onto the dispense station is detected, or at some other appropriate time, etc.

Upon initiation of the authentication query (222), PLC 102 activates interrogator (224). Interrogator 130 activates the appropriate station antenna 132A-132N to generate an interrogation signal. The electronically readable label transmits the stored product information, which is detected by the relevant station antenna 132A-132N and sent to the interrogator. The interrogator receives the product information from the label and passes it to the PLC 102 for processing. PLC 102 receives the product information (226) and determines whether the product information matches the product information corresponding to the specified product for that dispense station (228). If so, the product container is considered to be authenticated. PLC 102 may then generate a control signal to open electronically controlled valve, causing the contents of product container to empty into the dispense tank, or otherwise activate dispensing of the chemical product from the product container (230). If the product is not authenticated, however, PLC 102 may generate an error message to that effect (232). The error message may indicate the relevant dispense station, the specified chemical product for that dispense station, the actual (incorrect) chemical product currently loaded onto the dispense station, a date and time stamp, technician identification information, and other information as may be appropriate. The PLC may display the error message on user interface 106 or may generate and send the error message via e-mail, voice mail, text message, cell phone, pager, personal digital assistant, or other form of electronic communication. The PLC 102 may further activate a station lock-out condition (234). When the station lock-out condition is activated, system 100 is prevented from dispensing or otherwise using the incorrectly loaded product. For example, in a chemical dispense system in which chemical product totes are loaded and emptied into tanks at a dispense station, such as that shown in FIG. 1, the station lock-out may prevent valve 146A-146N at the relevant station from opening and emptying the contents of the incorrectly loaded container into tank 144A-144N. In dispense systems in which the product container is loaded directly into the dispenser, such as those used in laundry or warewashing applications, the station lock-out may prevent dispensing of the incorrectly loaded chemical product into the laundry or warewashing system.

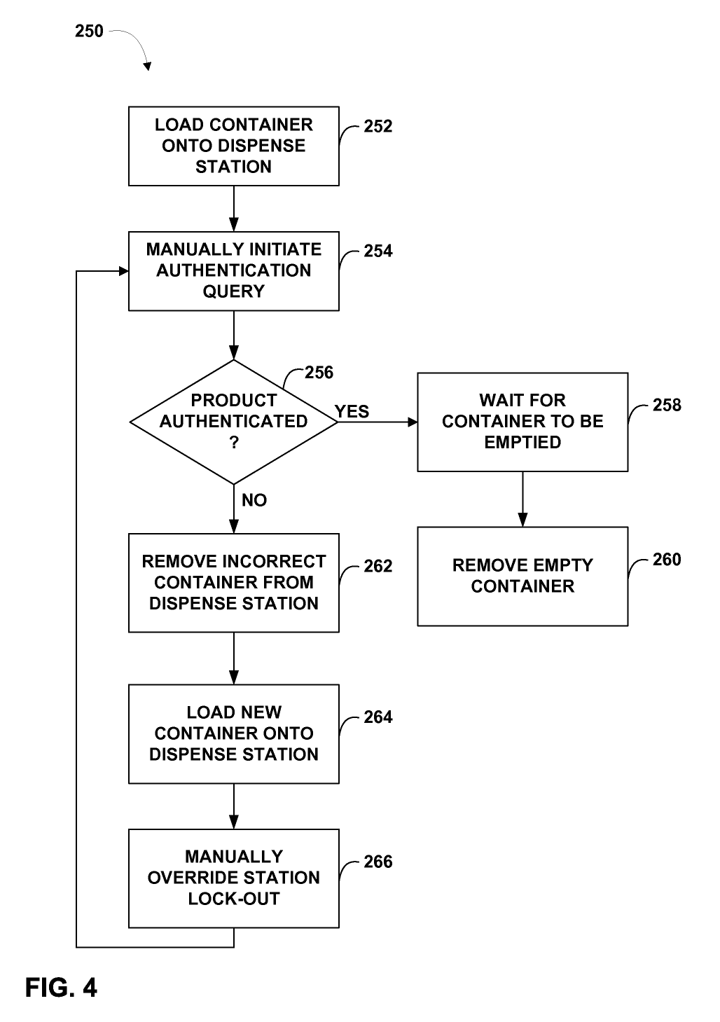

FIG. 4 is a flowchart illustrating an example process performed by a technician to load a product container and set up a dispense station (250). The technician loads the product container onto the dispense station (252). This may be done manually in the case of relatively small containers or machine assisted in the case of larger containers. The technician may then manually initiate an authentication query (254). The command may be entered via a text command, touch screen, mouse click, push button or other means of entering a command into the system. In systems in which the authentication query is automatically generated, this step may be eliminated. If the system authenticates the product (256) the technician waits for the container to become empty (258). In some examples, the technician simply waits for the container to become empty by checking it periodically. As another example, a container empty message or indicator may be automatically generated. Once the product container is empty, the technician may, either at their convenience or on a predetermined schedule, remove the empty product container from the dispense station and load a new product container into the dispense station (260).

If the system does not authenticate the product (256) the technician removes the incorrect product container from the dispense station (262) and replaces it with a new product container (264). The technician may then manually override the station lock-out (266). The technician may then initiate another authentication query (254). Alternatively, the system may be set up to automatically override the station lock-out when a product container containing the specified product is authenticated. In addition, a technician may override a station lock-out when the product is not authenticated due to a missing or wrong tag and leave the product container on the dispense station (e.g., without removing or replacing the non-authenticated product container).

Various embodiments of the invention have been described. These and other embodiments are within the scope of the following claims.

1. A system comprising:
a plurality of electronically readable labels, each associated with a different one of a plurality of product containers, wherein each electronically readable label stores product information that identifies a chemical product in the associated product container and transmits the product information in the presence of an interrogation signal;
a plurality of dispense stations, each associated with a specified one of a plurality of chemical products and each of which receives a product container containing a chemical product to be dispensed, each dispense station comprising:
a dispensing tank;
an electronically controllable valve that controls emptying of the chemical product from the product container into the dispensing tank; and
a station antenna that generates the interrogation signal and receives the product information transmitted by the electronically readable label;
an interrogator that activates the station antenna to generate the interrogation signal and receives the product information from the station antenna; and
a controller that receives the product information from the interrogator, determines whether to authenticate the received product information and generates a control signal based on the determination.

2. The system of claim 1 wherein the controller generates a control signal that opens the electronically controllable valve to empty the chemical product from the product container into the dispensing tank when the product information has been authenticated.

3. The system of claim 1 wherein the controller authenticates the received product information when the received product information matches product information corresponding to the specified one of the plurality of chemical products associated with the dispense station.

4. The system of claim 1 wherein the controller further generates a station lock-out when the received product information is not authenticated.

5. The system of claim 4 where in the controller prevents dispensing of the chemical product when the station lock-out is activated.

6. The system of claim 1 wherein the controller generates a control signal that prevents opening of the electronically controllable valve when the received product information is not authenticated.

7. The system of claim 1 wherein the electronically readable label comprises one of an RFID tag, a bar code or a conductive ink.

8. The system of claim 1 further comprising a reader/writer that encodes the electronically readable label with the product information.

9. The system of claim 1 wherein the controller generates an error message when the received product information is not authenticated.

10. The system of claim 9 wherein the error message comprises one of a visual alert or an audible alert.

11. The system of claim 9 wherein the error message comprises an electronic communication.

12. A method comprising:
receiving product information that identifies a chemical product contained in a product container loaded onto a dispense station;
comparing the received product information with product information corresponding to a specified chemical product associated with the dispense station;
authenticating the received product information when the received product information matches the product information corresponding to the specified chemical product; and
preventing dispensing of the chemical product when the received product information does not match the product information corresponding to the specified chemical product.

13. The method of claim 12 further comprising permitting dispensing of the chemical product when the received product information has been authenticated.

14. The method of claim 12 further comprising preventing dispensing of the chemical product when the received product information is not authenticated.

15. The method of claim 12 further comprising generating an audible, visual or electronic alert when the received product information is not authenticated.

16. A system comprising:
a plurality of electronically readable labels, each associated with a different one of a plurality of product containers, wherein each electronically readable label stores product information that identifies a chemical product in the associated product container and transmits the product information in the presence of an interrogation signal;
a plurality of dispense stations, each associated with a specified one of a plurality of chemical products and each of which receives a product container containing a chemical product to be dispensed;
a plurality of station antennas, each associated with a different one of the plurality of dispense stations and each of which generates the interrogation signal and receives the product information transmitted by the electronically readable label associated with the product container received by the associated dispense station;
an interrogator that activates the station antennas to generate the interrogation signal and receives the product information from the station antenna; and
a controller that receives the product information from the interrogator, determines whether to authenticate the received product information and generates a control signal based on the determination.

17. The system of claim 16 wherein the controller authenticates the received product information when the received product information matches product information corresponding to the specified one of the plurality of chemical products associated with the dispense station.

18. The system of claim 16 wherein the controller further generates a station lock-out when the received product information is not authenticated.

19. The system of claim 18 wherein the controller prevents dispensing of the chemical product when the station lock-out is activated.

20. The system of claim 16 wherein the electronically readable label comprises one of an RFID tag, a bar code or a conductive ink.
